(19) United States
(12) Patent Application Publication
(10) Pub. No.: US 2010/0122563 A1
(43) Pub. Date: May 20, 2010

(54) METHOD AND APPARATUS FOR FORMING BEND-CONTROLLING STRAPS IN SHEET MATERIAL

(75) Inventor: Max W. DURNEY, San Francisco, CA (US)

Correspondence Address: MORGAN, LEWIS & BOCKIUS, LLP (SF), ONE MARKET SPEAR STREET TOWER, SAN FRANCISCO, CA, 94105, US

(73) Assignee: Industrial Origami, Inc., San Francisco, CA (US)

(21) Appl. No.: 12/619,593

(22) Filed: Nov. 16, 2009

Related U.S. Application Data
(60) Provisional application No. 61/115,095, filed on Nov. 16, 2008.

(51) Int. Cl. B21D 37/10; B21D 31/02; B29B 7/00; B32B 3/00

(52) U.S. Cl. 72/379.2; 72/472; 72/455; 72/326; 428/542.8; 428/156

(57) ABSTRACT

A substantially two-dimensional sheet material is configured for bending along a bend line to form a three-dimensional article. The sheet material includes a sheet of elastically and plastically deformable material, one portion of the sheet material located on one side of the bend line and another portion located on the opposing side of the bend line, one portion being displaced relative to the another portion in the direction of the thickness of the sheet material, and/or a plurality of shear lengths extending along the bend line separating the one and another portions of the sheet material. At least a pair of adjacent shear lengths define a strap interconnecting the one and another portions of the sheet material. A tooling assembly is configured for forming the bend-controlling straps and includes a punch assembly and a die assembly dimensioned and configured to move relative to one another, a punch block having a continuous shear edge, the punch block removably secured on the punch assembly, and/or a die block having an interrupted shear edge broken into shear edge segments by one or more recesses, the die block removably mounted on the die assembly, wherein moving one of the punch assembly and the die assembly toward the other, the continuous shear edge of the punch block cooperates with the shear edge segments for impart shear lengths upon the sheet material along the predetermined bend line. A method of using the tooling assembly and forming the sheet material is also described.

### CROSS-REFERENCES TO RELATED APPLICATIONS

This application claims priority to U.S. Provisional Patent Application No. 61/115,095 filed Nov. 16, 2008, entitled METHOD AND APPARATUS FOR FORMING BEND-CONTROLLING STRAPS IN SHEET MATERIAL, the entire contents of which is incorporated herein for all purposes by this reference.

### BACKGROUND OF THE INVENTION

1. Field of the Invention

This invention relates, in general, to methods and apparatus for forming bend-controlling straps in sheet materials.

2. Description of Related Art

Various techniques or manufacturing processes for forming slits, grooves, displacements and other means in a wide variety of sheet materials that precisely control bending of the sheet materials are known. Such means include laser cutting, water jet cutting, stamping, punching, molding, casting, stereo lithography, roll forming, machining, chemical-milling, photo-etching and the like. Such means may be applied to numerous structures which are formed from sheet materials. An example of one type of structure which can be formed from sheet metal and yet require precision and complex bending is an electronic component chassis of the type used for computers. Other types of structures may include electrical enclosures, automotive components, transport components, construction components, HVAC components, appliances, airplane components, tracks, audio receivers, television sets, DVD players, and the like.

For example, U.S. Pat. No. 7,152,449 discloses the slitting and/or grooving of sheet materials and mounting components to the flat sheets using “pick-and-place” techniques in which the components are mounted to the flat sheets prior to folding of the sheets. The sheets may then be folded into enclosures or housings in which all of the components are spatially related in the desired positions inside the housing. The “pick-and-place” techniques greatly reduce cost, as does the ability to fold a flat sheet into a precisely dimensioned enclosure using relatively low-force bending techniques. While such sheet materials can be formed using laser cutting or water jet cutting processes, such processes are typically relatively expensive. Other techniques can be employed either in place of, or in addition to, the foregoing. Such other processes include displacement-forming techniques such as punching, stamping, roll-forming and the like. The displacement-forming processes are well suited for use with sheet materials and are typically, but not necessarily, less expensive than the cutting processes.

A tool press may be utilized to produce displacements in the sheet materials. For example, U.S. Pat. No. 7,152,450 discloses various methods and devices for stamping such displacements into sheet materials. For example, turret presses and other soft-tooling means are generally conducive to relatively low-volume production including prototyping and other lower volume applications. Relatively high production tooling is often configured with stamping presses and other means, specifically designed for and dedicated to the production of a specific part or parts. In either case, the tool press includes tooling that includes one or more male punches with one or more corresponding female dies. The punch and die sets of such tooling are often formed of hardened steel or other hardened metals that are relatively expensive to fabricate. The precision of the tool press fabrication decreases due to the number of discrete hits which leads to punched parts of lesser quality. Dull punches and dies may also wear out in terms of alignment and further lead to “dull” parts, that is, parts in which the finished geometry and dimensions are less precise than the desired or designed geometry and dimensions. The punches and dies may be sharpened, however, such sharpening is generally expensive and time consuming, which may leads to down time of the tool press further contributing to increased expense and decreased throughput.

In light of the foregoing, it would be beneficial to have methods and apparatuses utilizing simplified tooling which overcomes the above and other disadvantages of known tool presses.

### BRIEF SUMMARY OF THE INVENTION

One aspect of the present invention is directed to a method for bending a substantially two-dimensional sheet material along a bend line to form a three-dimensional article, the method including the steps selecting a sheet of elastically and plastically deformable material, displacing one portion of the sheet material on one side of the bend line relative to another portion of the sheet material on the other side of the bend line, forming a plurality of shear lengths along the bend line, wherein at least a pair of adjacent shear lengths define a strap interconnecting the one and another portions of the sheet material, and/or bending the sheet material substantially along the bend line and across the strap.

The displacing step may include displacing the one portion of the sheet material relative to the another portion of the sheet material a displacement distance (D) that may be greater than approximately 60% of the thickness of the sheet material. The displacing step may include displacing the one portion of the sheet material relative to the another portion of the sheet material a displacement distance (D) that may be approximately equal to the thickness of the sheet material. The displacing step may include displacing the one portion of the sheet material relative to the another portion of the sheet material a displacement distance (D) that may be greater than the thickness of the sheet material.

The forming step may include forming one or more of the plurality of shear lengths with a substantially straight central portion. The forming step may include forming at least a pair of adjacent shear lengths with adjacent curved ends which define the strap. The forming step may include forming the curved ends with a radius of curvature (R) that may be greater than the thickness (T) of the sheet material. The forming step may include forming the curved ends with a radius of curvature (R) that may be greater than three times the thickness (T) of the sheet material.

Another aspect of the present invention is directed to a substantially two-dimensional sheet material configured for bending along a bend line to form a three-dimensional article, the sheet material including a sheet of elastically and plastically deformable material, one portion of the sheet material located on one side of the bend line and another portion located on the opposing side of the bend line, one portion being displaced relative to the another portion in the direction of the thickness of the sheet material, and/or a plurality of shear lengths extending along the bend line separating the one and another portions of the sheet material, wherein at least a pair of adjacent shear lengths define a strap interconnecting the one and another portions of the sheet material.

The one and another portions of the sheet material may be displaced relative to one another a displacement distance (D) that may be one of: greater than approximately 60% of the thickness of the sheet material; approximately equal to the thickness of the sheet material; or greater than the thickness of the sheet material. One or more of the plurality of shear lengths may include a substantially straight central portion. At least a pair of adjacent shear lengths may include adjacent curved ends which define the strap. The curved ends may have a radius of curvature (R) that may be greater than the thickness (T) of the sheet material, or may be greater than three times the thickness (T) of the sheet material.

A further aspect of the present invention is directed to a tooling assembly for forming bend-controlling straps in a sheet material suitable for bending along a predetermined bend line, the tooling assembly including a punch assembly and a die assembly dimensioned and configured to move relative to one another, a punch block having a continuous shear edge, the punch block removably secured on the punch assembly, and/or a die block having an interrupted shear edge broken into shear edge segments by one or more recesses, the die block removably mounted on the die assembly, wherein moving one of the punch assembly and the die assembly toward the other, the continuous shear edge of the punch block cooperates with the shear edge segments for impart shear lengths upon the sheet material along the predetermined bend line.

At least one of the punch block and the die block may be formed of hardened steel. The at least one of the punch block and the die block may be removably secured to a portion of the punch assembly or the die assembly that may be not formed of hardened steel. At least one of the punch block and the die block may have a symmetric profile having a plurality of continuous shear edges or interrupted shear edges, wherein upon wear of one of the plurality of shear edges, the at least one block may be rotated 180° for continued use of the at least one block. At least one of the punch block and the die block may be received within a channel of a respective punch or die assembly.

At least one of the punch block and the die block may be formed of a plurality of modular chips, each chip being substantially square-shaped and having a shear edge extending along each side thereof. A portion of the plurality of modular chips may be identical, each identical modular chip including a centrally located indentation forming a respective recess of the die block. A portion of the plurality of modular chips may be identical, each identical modular chip including a corner notch, wherein adjacent corner notches of adjacent identical modular chips form a respective recess of the die block. A portion of the plurality of modular chips may be identical, each identical modular chip including sloped edges providing a rooftop configuration for reducing the tonnage to effect shearing along the sheet material.

The punch blocks may include a plurality of continuous shear edges, and the die block may include at least one corresponding interrupted shear edge and at least one corresponding continuous shear edge. At least one of the punch block and die block may be electrical-discharged-machined hardened steel. Both the punch block and the die block may be electrical discharged machined from a single plate of pre-hardened steel plate. A plurality of punch blocks and a plurality of die blocks may be electrical discharged machined from a single plate of pre-hardened steel plate.

A supplemental component may be electrical discharged machined from the single plate of pre-hardened steel plate. The supplemental component may be selected from the group consisting of a bench supporting an ejector, a bench supporting a lance blade, a bench including a lance cavity, and a corner trimmer.

One of the punch assembly and the die assembly may include a shoe to which the corresponding punch block or die block may be removably mounted, and the tooling assembly further may include one or more shims to space a corner trimmer from the shoe.

A punch press machine may include any of the above-mentioned tooling assemblies. A method for forming bend controlling straps in a sheet material may include the steps providing the tooling assembly described above, and may further include inserting a sheet material between the punch strips and the die block, and/or forming straps on the sheet material. A sheet material may be formed by any of the above-described methods. A three-dimensional article by any of the above-described methods.

Any of the above-described three-dimensional articles may be selected from the group consisting of: electronic components, automotive components, transport components, construction components, appliance parts, truck components, RF shields, HVAC components, and/or aerospace components.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1A is an isometric view of an exemplary sheet material, and enlarged detail thereof, having bend-controlling straps in sheet material in accordance with various aspects of the present invention. FIG. 1B and FIG. 1C are side elevations of exemplary sheet material having displacements of approximately the thickness of the sheet material, and less than the thickness of the sheet material, respectively. FIG. 1D, FIG. 1E, FIG. 1F, and FIG. 1G are enlarged details of other exemplary bend-controlling straps with corresponding schematic views of the shear edges for producing the same.

FIG. 2A, FIG. 2B, and FIG. 2C are side cross-sectional views of an exemplary apparatus for forming bend-controlling straps in the sheet material of in accordance with various aspects of the present invention, the apparatus shown in progressive stages of the forming process.

FIG. 3 is an exploded isometric view of shear components of the apparatus of FIG. 2.

FIG. 4 is an isometric view of another exemplary apparatus having shear components similar to those shown in FIG. 2, the shear components having modular shear chips.

FIG. 5 is an isometric view of various modular shear blocks similar to those shown in FIG. 4.

FIG. 6 is an isometric view of the modular shear chips of FIG. 5 arranged in segments to form punch and die blocks for forming a corresponding bend line.

FIG. 7 is an isometric view of shear components of another exemplary apparatus having shear components similar to those shown in FIG. 2.

FIG. 8 is an isometric view of shear components of another exemplary apparatus similar to that shown in FIG. 2, schematically illustrating bend-controlling straps formed into a two-dimensional sheet material.

FIG. 9A, FIG. 9B, and FIG. 9C are isometric views of monolithic plates used to form the shear blocks for the apparatus of FIG. 8 in accordance with various aspects of the present invention.

FIG. 10A and FIG. 10B are cross-sectional views of portions of an exemplary plate similar to that shown in FIG. 9.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

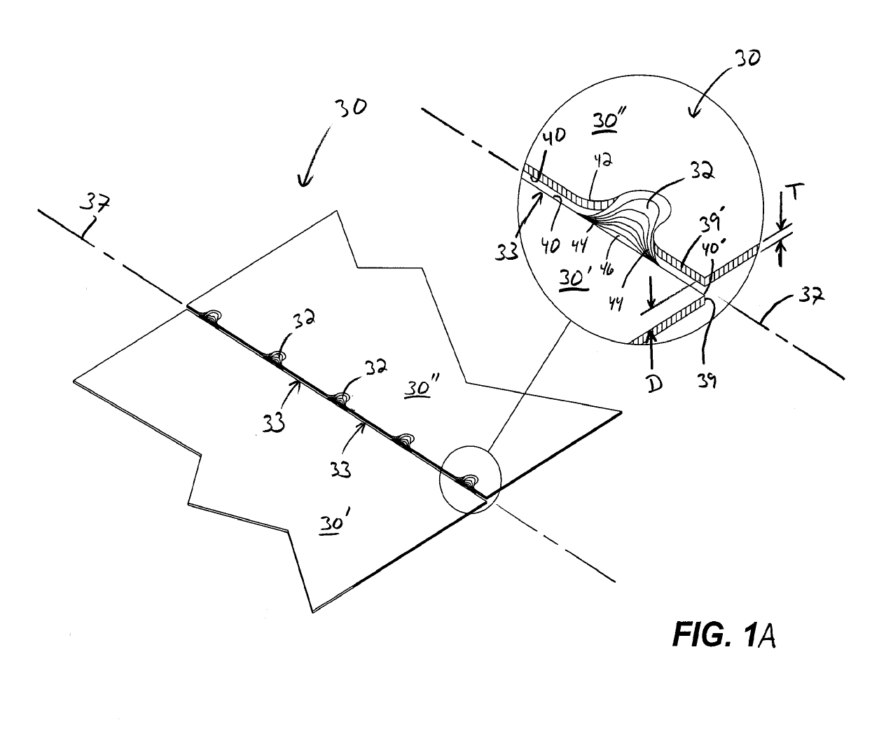

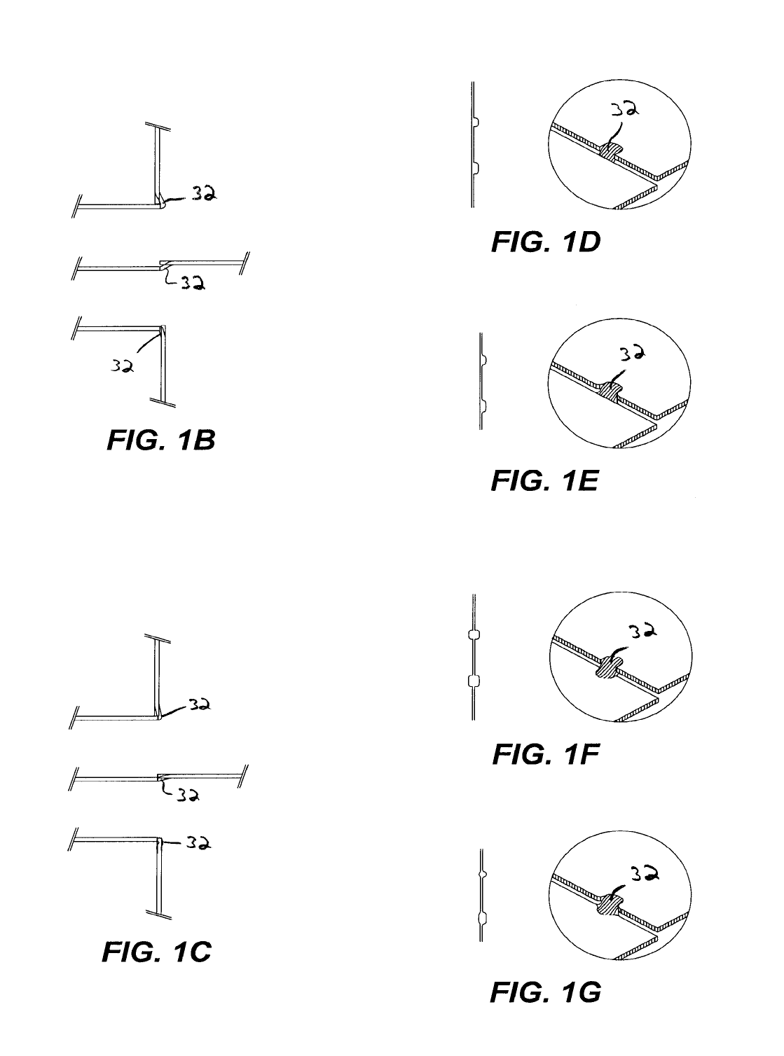

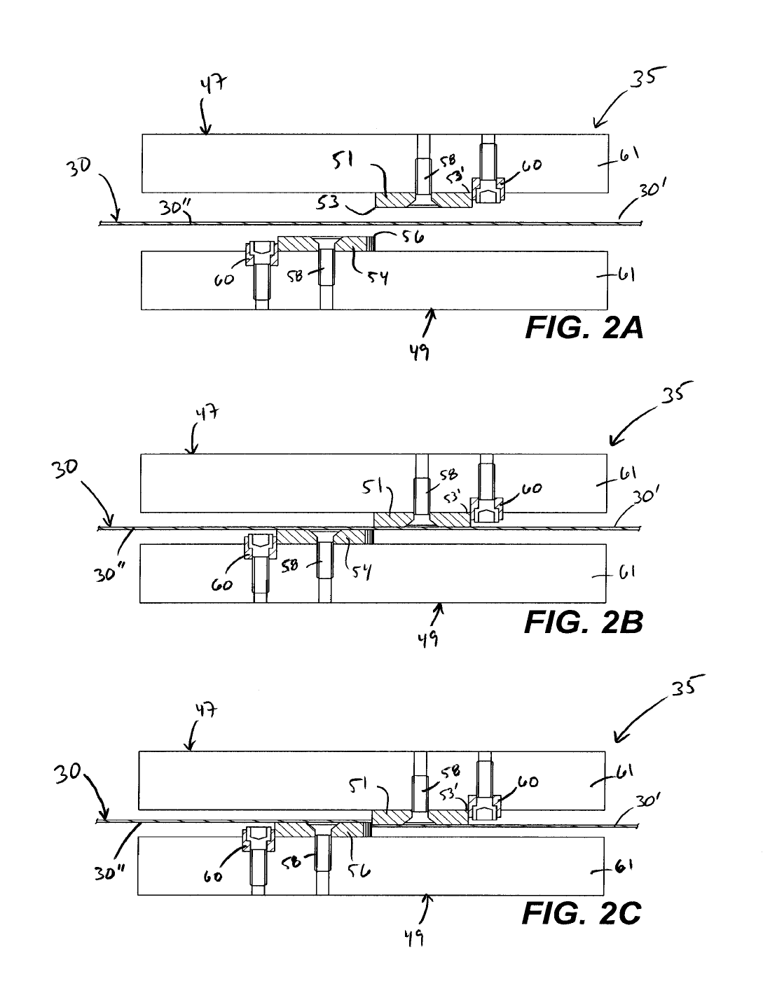

Turning now to the drawings, wherein like components are designated by like reference numerals throughout the various figures, attention is directed to FIG. 1A which illustrates an exemplary substantially two-dimensional (2D) sheet material work piece 30 having bend-controlling straps 32 formed by interrupted lengths of shear or near-shear lines of weakness (“shear length”) 33 to facilitate bending the 2D sheet material into a three-dimensional (3D) shape. FIG. 2A through FIG. 2C illustrate an exemplary tool press, generally, designated by the numeral 35, that may be used to form the bend-controlling straps in the sheet material in to facilitate bending the sheet material into 3D shapes. As used herein, the terms “tool press” and “punch press” are largely synonymous in that they are used to refer to a machine or system which includes tooling that having one or more punches with one or more corresponding dies which have cooperating shear edges configured to punch, stamp or press shapes into the sheet material work piece. Such machines or systems may include stamping presses, hydraulic presses, pneumatic presses and other suitable tooling. The exemplary system is particularly well suited to be used to form sheet materials having engineered fold lines which facilitate low-force and/or precision bending along predetermined fold lines.

In this regard, the apparatus of the present invention is particularly forming for bend-controlling displacements in 2D sheet materials to form engineered fold lines of various fold geometries and configurations which may be used instead of, or in addition to other engineered fold lines including, but not limited to, those disclosed by U.S. Pat. No. 6,481,259, U.S. Pat. No. 6,877,349, U.S. patent application Ser. No. 11/180,398 (now U.S. Patent Application Publication No. 2006/0021413 A1), U.S. Pat. No. 7,152,449, U.S. Pat. No. 7,152,450, U.S. patent application Ser. No. 10/821,818 (now U.S. Patent Application Publication No. 2005/0005670 A1), U.S. Pat. No. 7,263,869, U.S. Pat. No. 7,222,511, U.S. patent application Ser. No. 11/357,934 (now U.S. Patent Application Publication No. 2006/0261139 A1), U.S. patent application Ser. No. 10/952,357 (now U.S. Patent Application Publication No. 2005/0064138 A1), U.S. patent application Ser. No. 12/028,713, U.S. patent application Ser. No. 11/384,216 (now U.S. Patent Application Publication No. 2006/0207212 A1), U.S. Pat. No. 7,350,390, U.S. patent application Ser. No. 11/374,828 (now U.S. Patent Application Publication No. 2006/0213245 A1), the entire contents of which patents and patent applications are incorporated herein for all purposes by this reference.

As described in the above-mentioned applications, some applications for the precision bending of sheet materials is in connection with the production of 3D articles including, but not limited to, electronic component chassis, automotive components, transport components, construction components, appliances parts, truck components, RF shields, HVAC components, aerospace components, and the like. Since laser cutting and water jet cutting may be somewhat more expensive, it may be particularly desirable to be able to form various 3D articles, such as a chassis for electronic equipment, and numerous other lower cost housings and the like, using-relatively lower cost, high-production displacement forming techniques such as punching, stamping, roll forming and the like. Depending on the particular context of the manufacturing application, the displacement forming techniques may be used as either an alternative to, or as an adjunct to, the cutting and/or other forming techniques. The present application, therefore, illustrates how these displacement forming processes can be applied to sheet materials, which sheet materials may be later bent to form various 3D articles such as those mentioned above.

With reference to FIG. 1A, the bend-controlling straps 32 may be formed along one or more predetermined or desired bending lines 37. In contrast to the slits, tongues, and displacements discussed in the above-mentioned patents and patent applications, the bend-controlling straps of the present invention are generally formed as one portion 30′ of the sheet material is displaced relative to another portion 30″ of the sheet material to form interrupted lengths of shear 33 are formed along bend line 37 extending between the two portions 30′, 30″ of the sheet material.

As can be seen in FIG. 1A, the two portions 30′, 30″ of the sheet material are displaced a distance D that is greater than the thickness of the sheet material. One will appreciate, however, that the displacement distance may vary depending upon application. For example, the displacement distance may be approximately equal to the thickness of the sheet material, as shown in FIG. 1B, or the displacement distance may less than the thickness of the sheet material, as shown in FIG. 1C. Preferably, the displacement distance is sufficient to cause of least partial shear through the sheet material, or sufficient to produce near-shear, that is, sufficient to produce a line of significant weakness that will shear upon bending. For example, with some materials, a displacement distance of approximately 60% the thickness of the material will cause partial shear. In such instances, there is no shear through the sheet material while sheet material remains in its unfolded 2D state, however, upon folding the sheet material into a 3D article in sheet material will effectively break along the lengths of partial shear. Accordingly, one will appreciate that the tolerances of vertical displacement necessary to effectively form the bend lines of the present invention may be less than those necessary to form prior engineered bend lines.

Having the displacement distance approximately equal to, or less than the sheet material thickness may have certain advantages. Generally, the shear lengths 33 have opposing shear faces 39 and opposing shear edges 40 (e.g. sharp corners) as shown in FIG. 1A. In instances where the displacement distance is approximately equal to, or less than the sheet material thickness may provide for engagement between a shear edge 40′ and a corresponding opposed shear face 39′ to produce edge-to-face engagement during bending in a manner similar to that described in the above-mentioned patents and patent applications. One will appreciate that the straps may have various geometries as shown in FIG. 1D through FIG. 1G.

In various embodiments, the ends of the shear lengths are provided with relatively large-radii curved ends 42, however, one will appreciate that curved ends are not essential. In such embodiments, the radii of the curved ends are greater than the thickness of the sheet material, preferably two or three times greater than the thickness of the sheet material, and more preferably more than three times the thickness, and even several times as thick in certain instances. Such a configuration facilitates “strap” behavior that subjects portions of the sheet material immediately adjacent to large-radii ends to tension and torsion, as is described in U.S. Patent Application Publication No. US 2008/0098787 A1, the entire contents of which patent application is incorporated herein for all purposes by this reference. These portions or half straps 44 immediately adjacent the ends generally experience greater stress and deformation during bending. Using the half straps serves to realign such stresses and deformations to reduce, minimize, and/or prevent propagation of shear through strap 32 during bending, as well as during subsequent vibrations and cyclical or simple loading. The half straps may also serve to facilitate precision bending along the bend line.

Portions of the sheet material intermediate the half straps generally undergo greater pure bending with relatively less torsion, as compared to the portions immediately adjacent the end of the shear length. In particular, extending between adjacent half straps are intermediate strap portions or mid-zones 46 that are relatively removed from the large-radii ends but lying between two adjacent large-radii ends. These intermediate portions are generally subjected to more pure bending, that is, bending of the structures which results in compression along internal surfaces along the bend line and tension along external surfaces along the bend line with minimal torsion. In contrast, the half straps are generally subjected to relatively high tension and torsion but subjected to relatively less pure bending, or possibly minimal pure bending, or no pure bending. As such, one will appreciate that the lengths of the intermediate portions may vary as the half straps may primarily be responsible for facilitating precision bending along the bend line. Advantageously, longer intermediate portions may result in a reduced number of displacements required along the bend line, increased area of material interconnecting portions of sheet material on either side of the bend line, and/or other advantages.

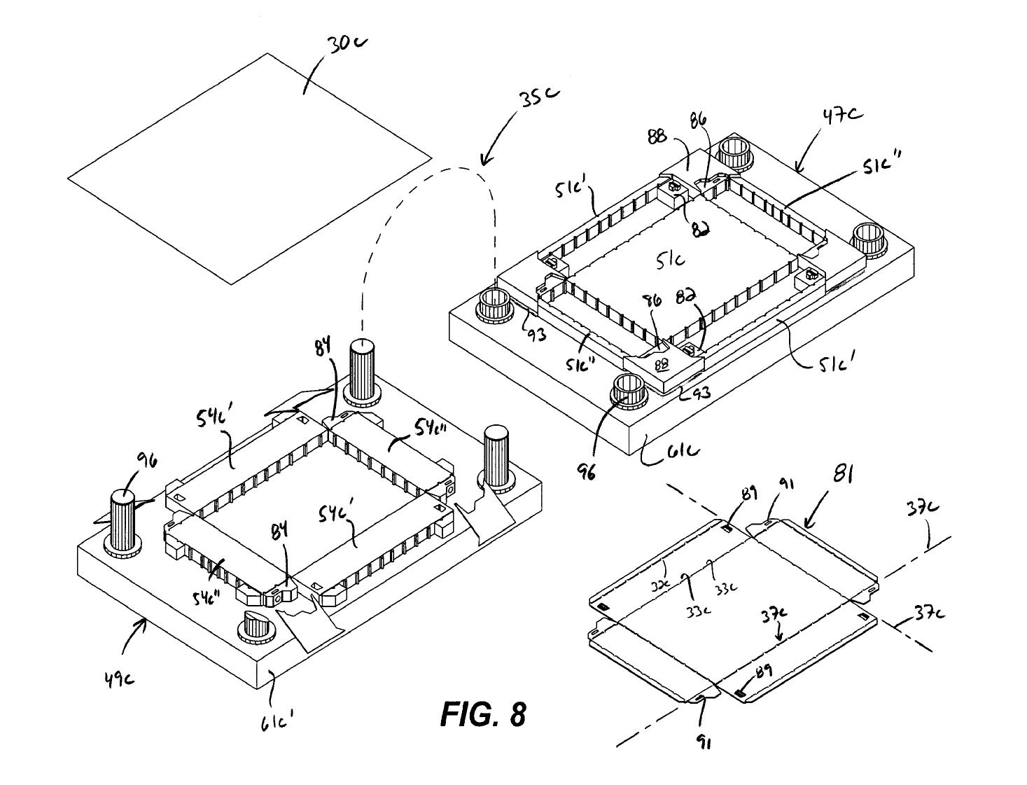

With reference to FIG. 2A through FIG. 2C, tool press 35 includes tooling in the form of an upper punch assembly 47 and a corresponding lower die assembly 49 which are preferably keyed to one another in a conventional manner, for example, with slides such that they reciprocate toward and away from one another in an otherwise conventional manner (see, e.g., FIG. 8). The illustrated embodiment is “form down” in that the straps are formed downwardly as one portion 30′ of the sheet material is displaced downwardly with respect to another portion 30″ of the sheet material (see, e.g., FIG. 1A and FIG. 2C). One will appreciated that the assembly could be reversed with the die assembly mounted above the punch assembly (i.e., “form up”), or with a combination form-up and form-down configurations. Similarly, the punch and die assemblies may be movably mounted relative to one another in some other suitable fashion. For example, the punch and die assemblies may be arranged to move horizontally with respect to one another.

The illustrated vertically oriented configuration has certain advantages. For example, the vertically oriented configuration allows your work piece to merely be placed upon the lower assembly and held in place by the force of gravity. This is particularly useful for “clobbering”, that is, stamped without the use of a stripper. For example, when the punching process also shears the peripheral shape of the sheet material, it is generally not necessary to specifically locate the work piece with respect to the upper and lower assemblies. In this case, a coil stand and feeder may be provided to feed coil stock to the tool press, either in addition to or instead of hand placement and mechanical placement as well.

As shown in FIG. 2A through FIG. 2C, the tool press may be used to selectively shear the sheet material 30 to form one or more shear lengths 33 along bend line 37, which shear lengths form one or more bend-controlling straps 32 in the sheet material. One will appreciate that the tool press may include additional features that may provide the sheet material with a number of other features such as apertures, recesses, protrusions, tabs, etc. (see, e.g., FIG. 8). One will also appreciate that the tool press may also be configured to provide fewer or additional displacement features and/or cut or form the work piece to a particular length and/or shape (see, e.g., FIG. 8).

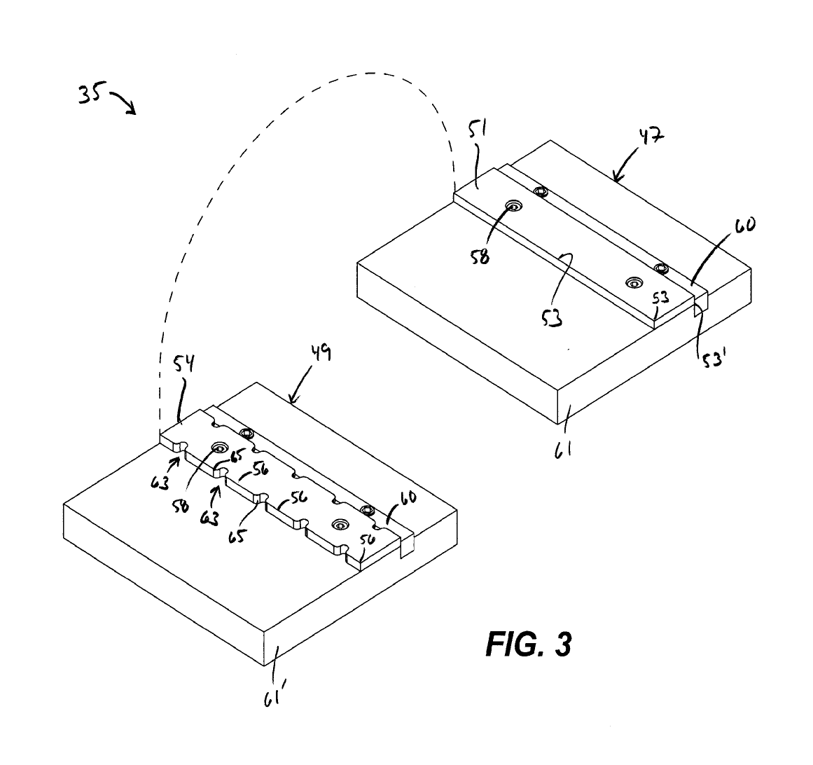

With reference to FIG. 2A, the upper punch assembly includes a punch block 51 having a continuous shear edge 53, while the lower die assembly includes a die block 54 having an interrupted shear edge 56. The cooperating continuous and interrupted shear edges 53, 56 may also be seen in FIG. 3. Although the upper and lower assemblies are illustrated in an open-book fashion in FIG. 3, one will appreciate that the upper and lower assemblies are generally configured to reciprocate up and down relative to one another. As the upper and lower assemblies move toward one another, the punch block abuts against an upper surface of one portion 30′ of the sheet material while the die block abuts against a lower surface of the other portion 30″ of the sheet material, as shown in FIG. 2B, and upon continued motion, punch block 51 displaces one portion 30′ downwardly below the upper surface of lower die block 54 to cause partial or full shear along the shear lengths of the sheet material. The actual amount of travel between the upper and lower assemblies may be varied depending upon the desired amount of shear (e.g., greater than the thickness of the sheet material, substantially equal to material thickness, or less than the material thickness).

In the illustrated embodiment, punch block 51 and die block 54 are removably secured to their respective assemblies by countersunk machine screws 58, and holding blocks 60, removably secured with countersunk cap screws, are provided to prevent the punch and die blocks from scissoring outward left and right relative to one another. One will appreciate that various means may be utilized to removably secure and position the punch, die, and holding blocks including, but not limited to, threaded fasteners, dowels and/or other suitable means.

The configuration of the illustrated punch and die blocks provides for very simplified tooling, both in terms of cost and design. For example, only the punch and die blocks need be formed of hardened materials such as hardened steel, and the holding blocks may be formed of hardened materials such as hardened steel if excessive wear-and-tear is an issue. Such configuration allows reduced processing time for fabrication thereof as only a limited number of are formed of hardened materials. However, the assembly shoes 61 may be formed of non-hardened mild steel. As such, the shoes may thus be milled and otherwise fabricated much less expensively than if using hardened metals.

Moreover, punch block 51 and die block 54, as well as holding blocks 60, have a relatively simple geometry and uniform thickness, as shown in FIG. 3. As such, the amount of machining to form these components is relatively less as compared to the complex machining required to fabricate conventional cooperating male/female punch and die sets. Moreover, punch block 51 has a simple, straight, continuous shear edge 53 which may require minimal machining One will appreciate that the punch block may be symmetrically formed to increase wear life. For example, once continuous shear edge 53 wears, one may simply unbolt punch block 51 from the upper punch assembly 47, turn it 180°, and rebolt it to the shoe, and utilize sheer edge 53, thus effectively doubling the wear life of the punch block.

With continued reference to FIG. 3, die block 54 is provided with a number of recesses 63 which extend inwardly away from interrupted shear edges 56. Although the illustrated recesses are semicircular, one will appreciate that other shapes may be used. Preferably, the recesses and interrupted shear edges are filleted 65 in order to provide for the above described curved ends. Although such fillets are not essential to certain aspects of the present invention, such fillets are particularly advantageous as the sheet material curved ends 42 are particularly well suited to serve a stress reducers as described above. The recesses and/or fillets may be ground, hard milled, and/or electrical discharged machined (“EDM”), however, one will appreciate that the recesses may be formed by other suitable means. One will also appreciate that the die block may be pre-hardened and milled to form its shear edges before the recesses and/or fillets are machined, thus further simplifying fabrication thereof.

One will also appreciate that the punch and die blocks illustrated in FIG. 3 may be provided as standard-length stock and cut down to a desired length depending upon application. Accordingly, one will appreciate that the cost of tooling may further be reduced by effectively making the punch and die blocks having sheared edges into a commodity part that may be mass produced in relatively high volume.

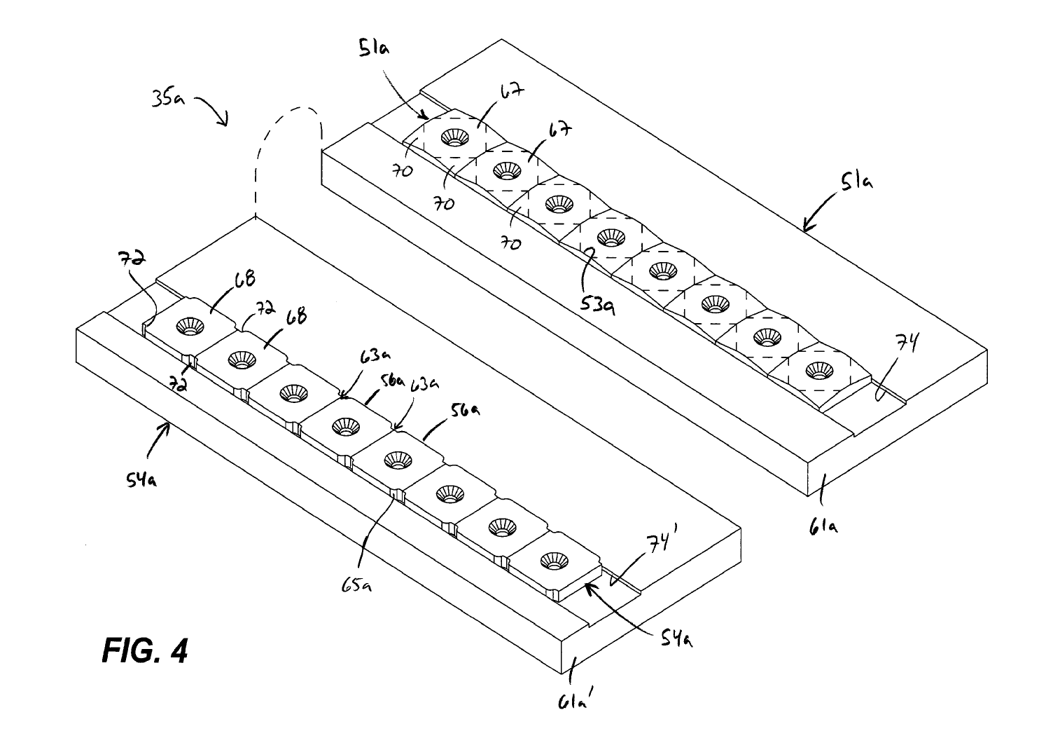

In various embodiments in accordance with various aspects of the present invention, the punch and die blocks may be similar to those described above, but be replaced with substantially modular designs, as shown by the exemplary embodiment of FIG. 4. In various embodiments, punch block 51a is formed of one or more punch chips 67 and die block 54a is formed of one or more die chips 68. One will appreciate that the chips are “standardized” in that a user may simply select a desired type of chip and sufficient number thereof to form a punch and die block set for forming a bend line of a desired length.

As shown in FIG. 4, punch chips 67 may have substantially straight edges, but are provided with sloped corners 70. Such sloped corners may be provided for a “rooftop” configuration in order to reduce tonnage required to effect shear. One will appreciate that the sloped corners may be ground, or otherwise provided by suitable means.

Die chips 68 may include corner notches 72 which, together with an adjacent corner notch of an adjacent die chip, form recess 63a to interrupt shear in a manner similar to that described above.

With continued reference to FIG. 4, one will appreciate that various means may be utilized to mount the punch and die blocks to their respective punch and die assemblies. In various embodiments, the punch and die blocks may be mounted in channels formed in the respective shoes of the punch and die assemblies. For example, punch block 51a may be situated within channel 74 formed in the respective shoe 61a of the punch assembly, while die block 54a may be situated within channel 74′ formed in the respective shoe 61a′ of the die assembly. As the punch and die shoes may be formed of non-hardened metals, the channel may be formed and otherwise fabricated or milled relatively inexpensively. The punch and die chips may be simply bored and countersunk to accommodate threaded fasteners (not shown) for removably mounting the punch and die chips within their respective shoes.

Turning now to FIG. 5, various punch and die chips are illustrated, each of which may be used to form a punch or die block of a desired configuration. For example, a number of punch chips 67 may be collectively mounted on a punch assembly to form punch block 51a, while a number of die chips 68 may similarly form die block 54a in the manner described above and shown in FIG. 4. Alternatively, other types of chips may be utilized to form alternative punch and die blocks.

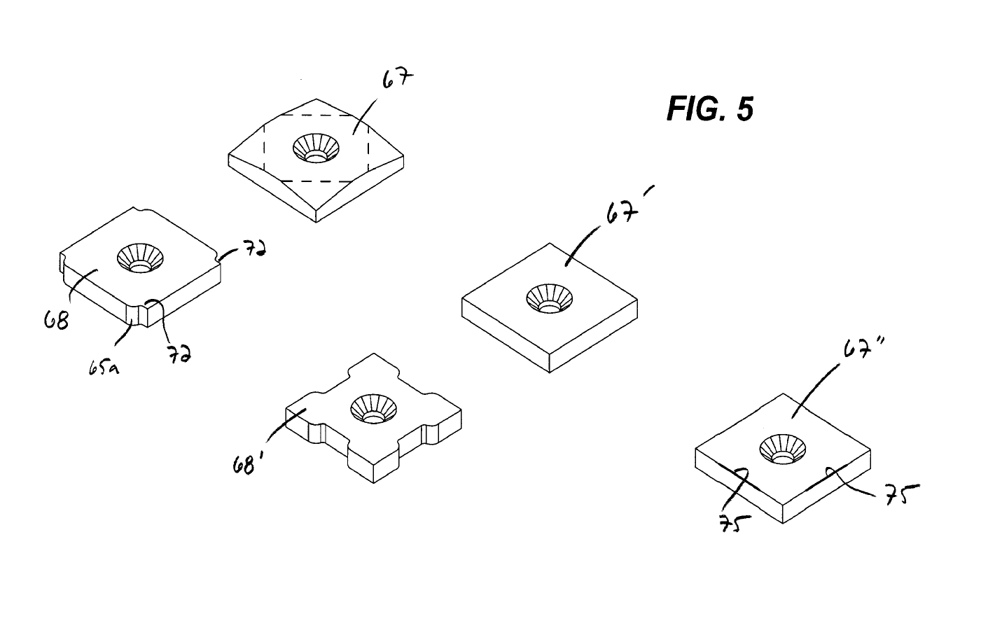

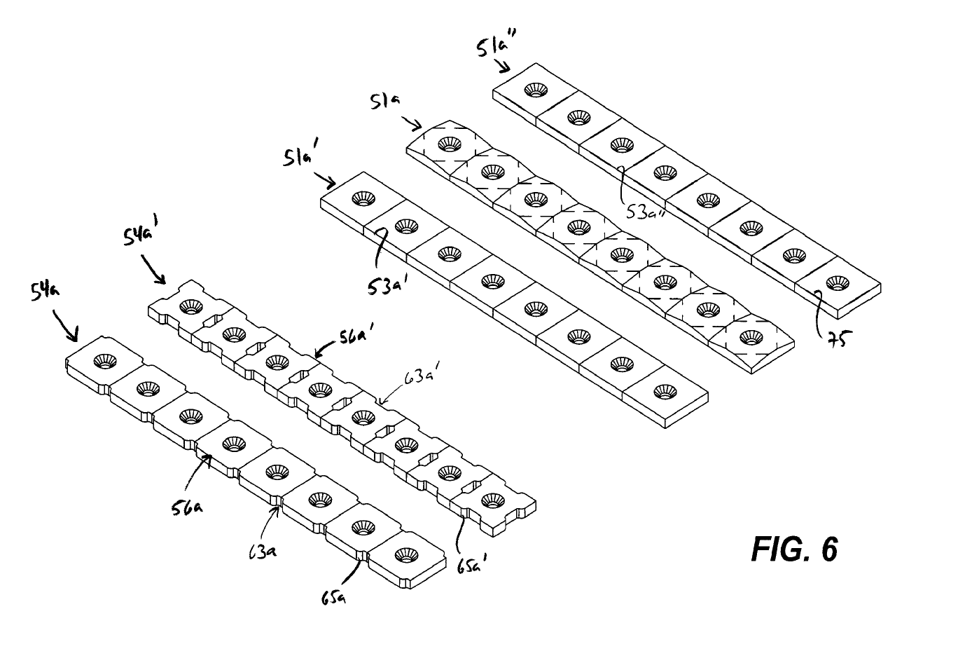

For example, a number of punch chips 67′, which simply have straight shear edges extending along each side thereof, may be collectively mounted on a punch assembly to form punch block 51a′ having a straight continuous shear edge 53a′, as shown in FIG. 6, while a number of punch chips 67″, which have blunted central edges 75 along each side thereof, may be collectively mounted on a punch assembly to form punch block 51a″ also having a continuous shear edge 53a″ but with blunted segments, also shown in FIG. 6. Such blunted segments may be aligned with corresponding recesses of the die block to smooth the transition at one end of the strap.

Similarly, a number of die chips 68′, which have centrally located indentations 77 along each side thereof, may be collectively mounted on a die assembly to form die block die block 54a′ having an interrupted shear edge 56a′, as is also shown in FIG. 6.

One will appreciate that the symmetric design of the punch and die chips provide for increased wear-and-tear. For example, each punch and die chip may be provided with eight shear edges, four upper edges along each of its upper four-square sides, and four lower edges along each of its lower four-square side. Thus, as one shear edge of the punch or die chip wears, a user may simply loosen the respective chip, rotate it 90°, 180° or 270°, and/or flip it upside down and again rotate it 90°, 180° or 270°.

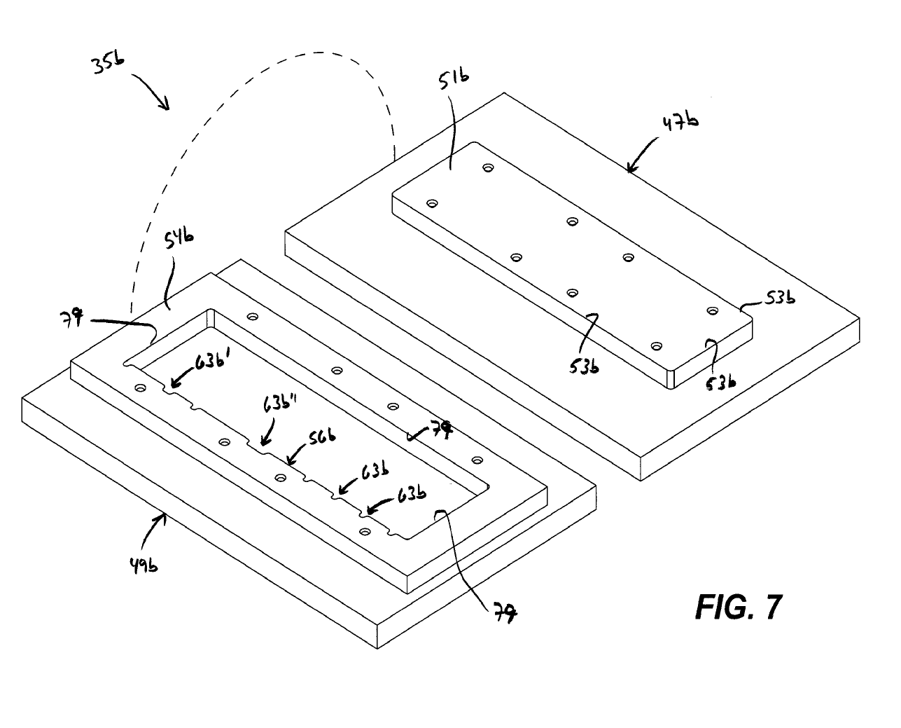

In various embodiments in accordance with various aspects of the present invention, the punch and die blocks may be similar to those described above, but may include multiple shear edges in order to shape the sheet material in addition to providing straps and shear lengths along a desired bend line, as shown by the exemplary embodiment of FIG. 7. In various embodiments, punch block 51b is formed with a plurality of continuous shear edges 53, while the die block 54b is formed with at least one interrupted shear edge 56b and of one or more cooperating shear edges 79 which may be utilized to shape the sheet material. One will appreciate that numerous designs may be provided with incorporate one, two, three or more interrupted shear edge, and one, two, three or more cooperating shear edges.

In various embodiments, the punch and die blocks may be formed from a single plate of pre-hardened steel. As can be seen in FIG. 7, punch block 51b corresponds in shape to the void in die block 54b. As such, the punch block may be readily cut from the die block by EDM in an otherwise conventional manner. Further EDM machining may be utilized to cut recesses 63b into the die block. As such, such relatively simple tooling fabrication may contribute to a significant savings of time and money.

Turning now to FIG. 8, various embodiments may include a rather sophisticated arrangement of punch and die blocks formed from a single plate of pre-hardened steel, as well as other components formed from the same plate of pre-hardened steel. For the sake of clarity and consistency, the term “punch block” (and associated terms) will continue to refer to the upper block assembly and the term “die block” (and associated terms) will continue to refer to the lower block assembly. However, one will appreciate that recess are now formed in the upper “punch blocks” and thus the straps are effectively formed by the “punch blocks” instead of by the “die blocks”.

As can be seen in FIG. 8, a substantially flat sheet material 30c may be formed into an intermediate article 81 with a “single hit” of tool press 35c. In this exemplary embodiment, upper punch assembly 47c includes a central punch block 51c and four peripheral punch blocks 51c′ and 51c″, while the lower die assembly 49c includes a number of cooperating die blocks 54c′ and 54c″. Together, the punch and die blocks cooperate to form a number of shear lengths 33c and straps 32c along a number of bend lines 37c. In the illustrated embodiment, the bend lines are configured such that the intermediate article may be folded into a junction box. One will appreciate, however, that the intermediate article may have any number of configurations such that it may be folded into various 3D articles including, but not limited to electronic component chassis, automotive components, transport components, construction components, appliances parts, truck components, RF shields, HVAC components, aerospace components, and the like.

In addition, the assemblies include other components such as spring-loaded spring-clip benches 82, lance blade holders 84, lance cavity benches 86 and corner trimmers 88, which components are useful in providing other “events” or features in the sheet material. For example, the spring-clip benches may support tooling to form a spring clip tab 89 in intermediate article 81, and the lance blade holders may support a lance blade which cooperates with a lance cavity to form a latch protrusion 91 in the intermediate article complementary to the spring clip tab, such as those described in

U.S. Patent Application Publication No. US 2006/0277965 A1, the entire contents of which patent application is incorporated herein for all purposes by this reference.

As shown in FIG. 8, corner trimmers 88 may be spaced upwardly from punch assembly shoe 61c with shims 93 in order to raise the corner trimmer sufficient to cooperate with the profile of lance blade holder 84 to shear or cut off the corners of sheet material 30 to give shape to intermediate article 81. One will appreciate that other shear edges may be provided to otherwise shape the sheet material into the intermediate article.

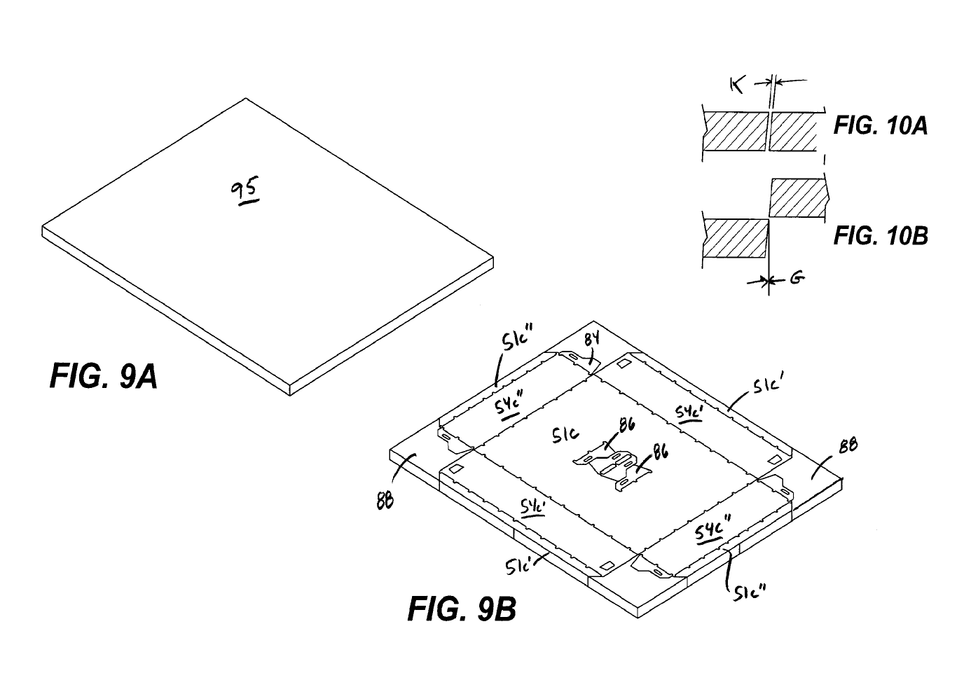

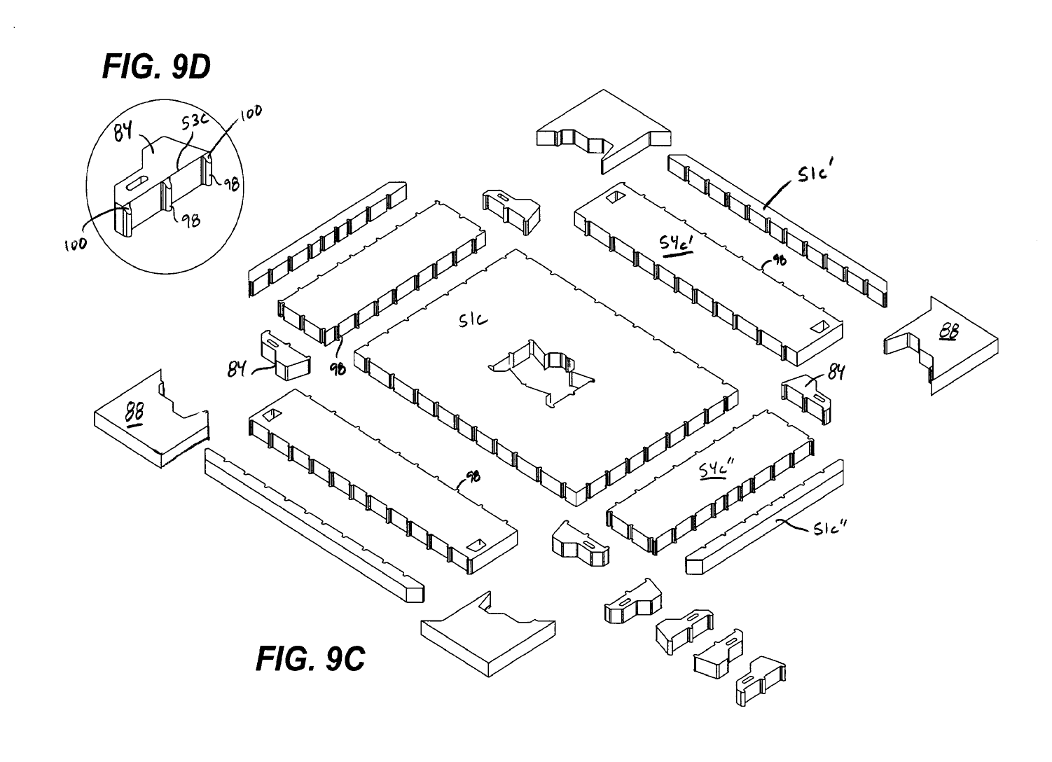

Turning now to FIG. 9A, FIG. 9B and FIG. 9C, it can be seen how the various punch and die blocks, and other components may be formed from a single plate of steel. Steel blank 95 may be pre-hardened and pre-ground. In addition, holes, interior cuts, and/or other apertures may be formed by drilling, counterboring, wire EDM and other suitable means to allow for dowels, lances, mounting bolts and other components (e.g., slide 96) if so desired, before or after hardening. Due to its uniform thickness and simple geometry of the steel blank, such fabrication is relatively simple and relatively inexpensive.

After the steel blank is hardened and ground, punch blocks 51c, 51c′, 51c″ and cooperating die blocks 54c′, 54c″ may be laid out in steel blank 95′ (see, e.g., FIG. 9B) and cut by wire EDM. In addition, other components including, but not limited to, lance cavity benches 86 may be laid out in central punch block 51c or other portion of the steel blank and cut by wire EDM. As also shown in FIG. 9B, corner trimmers 88 are formed at the corners of the steel blank Once the steel blank is cut by wire EDM, the various components may be separated from one another, as shown in FIG. 9C, and mounted on the respective punch and die assemblies 47c, 49c by threaded fasteners, such as those described above, or by otherwise suitable means.

In some instances, ribs 98 may be left on the die blocks 54c′, 54c″ in order to maximize efficiency and reduce machining costs. In particular, leaving the ribs may avoid additional EDM time and expense. Instead, the ribs my be simply ground to provide chamfers 100 at the tops thereof, which chamfers provide clearance for the formation of the straps.

In instances where the kerf of wire EDM exceeds the acceptable shear gap between cooperating shear surfaces, “sloped” wire EDM may be employed. For example, wire EDM may provide kerfs of approximately 0.012″ or more, while it may be desired to have a shear gap between cooperating shear surfaces of approximately 0.006″ or less. In accordance with various aspects of the present invention, one may “close the gap” by tilting the angle of wire EDM cutting as shown in FIG. 10A and FIG. 10B. In particular, tilting the angle of attack of wire EDM as shown in FIG. 10A provides a kerf (K) that may be approximately 0.012″ or more. When the opposing shear edges are utilized on corresponding punch and die blocks, the effective shear gap (G) may be significantly less, for example, approximately 0.006″ or less, as shown in FIG. 10B. One will appreciate that various angles may be utilized depending upon the desired result.

For convenience in explanation and accurate definition in the appended claims, the terms “up” or “upper”, “down” or “lower”, “inside” and “outside” are used to describe features of the exemplary embodiments with reference to the positions of such features as displayed in the figures.

In many respects various modified features of the various figures resemble those of preceding features and the same reference numerals followed by subscripts “a”, “b”, “c”, and “d” designate corresponding parts.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for bending a substantially two-dimensional sheet material along a bend line to form a three-dimensional article, the method comprising the steps:
selecting a sheet of elastically and plastically deformable material;
displacing one portion of the sheet material on one side of the bend line relative to another portion of the sheet material on the other side of the bend line;
forming a plurality of shear lengths along the bend line, wherein at least a pair of adjacent shear lengths define a strap interconnecting the one and another portions of the sheet material; and
bending the sheet material substantially along the bend line and across the strap.

2. The method of claim 1 wherein,
the displacing step includes displacing the one portion of the sheet material relative to the another portion of the sheet material a displacement distance (D) that is greater than approximately 60% of the thickness of the sheet material.

3. The method of claim 1 wherein,
the displacing step includes displacing the one portion of the sheet material relative to the another portion of the sheet material a displacement distance (D) that is approximately equal to the thickness of the sheet material.

4. The method of claim 1 wherein,
the displacing step includes displacing the one portion of the sheet material relative to the another portion of the sheet material a displacement distance (D) that is greater than the thickness of the sheet material.

5. The method of claim 1 wherein,
the forming step includes forming one or more of the plurality of shear lengths with a substantially straight central portion.

6. The method of claim 1 wherein,
the forming step includes forming at least a pair of adjacent shear lengths with adjacent curved ends which define the strap.

7. The method of claim 6 wherein,
the forming step includes forming the curved ends with a radius of curvature (R) that is greater than the thickness (T) of the sheet material.

8. The method of claim 7 wherein,
the forming step includes forming the curved ends with a radius of curvature (R) that is greater than three times the thickness (T) of the sheet material.

9. A substantially two-dimensional sheet material configured for bending along a bend line to form a three-dimensional article, the sheet material comprising:
a sheet of elastically and plastically deformable material;
one portion of the sheet material located on one side of the bend line and another portion located on the opposing side of the bend line, one portion being displaced relative to the another portion in the direction of the thickness of the sheet material; and
a plurality of shear lengths extending along the bend line separating the one and another portions of the sheet material, wherein at least a pair of adjacent shear lengths define a strap interconnecting the one and another portions of the sheet material.

10. The sheet material of claim 9 wherein,
the one and another portions of the sheet material are displaced relative to one another a displacement distance (D) that is one of: greater than approximately 60% of the thickness of the sheet material; approximately equal to the thickness of the sheet material; or greater than the thickness of the sheet material.

11. The sheet material of claim 9 wherein,
one or more of the plurality of shear lengths include a substantially straight central portion.

12. The sheet material of claim 9 wherein,
at least a pair of adjacent shear lengths include adjacent curved ends which define the strap.

13. The sheet material of claim 12 wherein,
the curved ends have a radius of curvature (R) that is greater than the thickness (T) of the sheet material, or is greater than three times the thickness (T) of the sheet material.

14. A tooling assembly for forming bend-controlling straps in a sheet material suitable for bending along a predetermined bend line, the tooling assembly comprising:
a punch assembly and a die assembly dimensioned and configured to move relative to one another;
a punch block having a continuous shear edge, the punch block removably secured on the punch assembly; and
a die block having an interrupted shear edge broken into shear edge segments by one or more recesses, the die block removably mounted on the die assembly;
wherein moving one of the punch assembly and the die assembly toward the other, the continuous shear edge of the punch block cooperates with the shear edge segments for impart shear lengths upon the sheet material along the predetermined bend line.

15. The tooling assembly of claim 14 wherein,
wherein at least one of the punch block and the die block are formed of hardened steel.

16. The tooling assembly of claim 15 wherein,
wherein the at least one of the punch block and the die block is removably secured to a portion of the punch assembly or the die assembly that is not formed of hardened steel.

17. The tooling assembly of claim 14 wherein,
wherein at least one of the punch block and the die block has a symmetric profile having a plurality of continuous shear edges or interrupted shear edges, wherein upon wear of one of the plurality of shear edges, the at least one block may be rotated 180° for continued use of the at least one block.

18. The tooling assembly of claim 14 wherein,
wherein at least one of the punch block and the die block is received within a channel of a respective punch or die assembly.

19. The tooling assembly of claim 14 wherein,
wherein at least one of the punch block and the die block is formed of a plurality of modular chips, each chip being substantially square-shaped and having a shear edge extending along each side thereof.

20. The tooling assembly of claim 19 wherein,
wherein a portion of the plurality of modular chips are identical, each identical modular chip including a centrally located indentation forming a respective recess of the die block.

21. The tooling assembly of claim 19 wherein,
wherein a portion of the plurality of modular chips are identical, each identical modular chip including a corner notch, wherein adjacent corner notches of adjacent identical modular chips form a respective recess of the die block.

22. The tooling assembly of claim 19 wherein,
wherein a portion of the plurality of modular chips are identical, each identical modular chip including sloped edges providing a rooftop configuration for reducing the tonnage to effect shearing along the sheet material.

23. The tooling assembly of claim 14 wherein,
the punch blocks includes a plurality of continuous shear edges, and the die block includes at least one corresponding interrupted shear edge and at least one corresponding continuous shear edge.

24. The tooling assembly of claim 14 wherein,
at least one of the punch block and die block are electrical-discharged-machined hardened steel.

25. The tooling assembly of claim 14 wherein,
both the punch block and the die block are electrical discharged machined from a single plate of pre-hardened steel plate.

26. The tooling assembly of claim 14 wherein,
a plurality of punch blocks and a plurality of die blocks are electrical discharged machined from a single plate of pre-hardened steel plate.

27. The tooling assembly of claim 26 wherein,
a supplemental component is electrical discharged machined from the single plate of pre-hardened steel plate.

28. The tooling assembly of claim 27
the supplemental component is selected from the group consisting of a bench supporting an ejector, a bench supporting a lance blade, a bench including a lance cavity, and a corner trimmer.

29. The tooling assembly of claim 28 wherein,
one of the punch assembly and the die assembly includes a shoe to which the corresponding punch block or die block are removably mounted, and
wherein the tooling assembly further comprises one or more shims to space a corner trimmer from the shoe.

30. A punch press machine including the tooling assembly of claim 14.

31. A method for forming bend controlling straps in a sheet material, the method comprising the steps:
providing the tooling assembly of claim 14;
inserting a sheet material between the punch strips and the die block; and
forming straps on the sheet material.

32. A sheet material formed by the method of claim 31.

33. A three-dimensional article formed from the sheet material of claim 32.

34. The three-dimensional article of claim 33, wherein the article is selected from the group consisting of: electronic components, automotive components, transport components, construction components, appliance parts, truck components, RF shields, HVAC components, and/or aerospace components.
